(19) United States
(12) Patent Application Publication
(10) Pub. No.: US 2004/0025829 A1
(43) Pub. Date: Feb. 12, 2004

(54) Method and computer programme for operating an internal combustion engine and an internal combustion engine

(76) Inventor: Gernot Wuerfel, Vaihingen/Enz (DE)

Correspondence Address: Walter Ottesen, Patent attorney, P O Box 4026, Gaithersburg, MD, 20885-4026, US

(21) Appl. No.: 10/381,938

(22) PCT Filed: Sep. 7, 2001
(86) PCT No.: PCT/DE01/03449

(30) Foreign Application Priority Data
Sep. 30, 2000 (DE) 10048608.8

(51) Int. Cl. F02B 17/00

(52) U.S. Cl. 123/295

(57) ABSTRACT

An internal combustion engine (10) is operated with a method wherein fuel is injected directly into a combustion chamber (12). The injection takes place at least from time to time so that, together with a corresponding supply of air into the combustion chamber (12), the air/gasoline mixture is present stratified in the combustion chamber (12). In order to reduce the gasoline consumption in the engine (10) via a higher compression ratio without the danger of knocking, it is suggested that the gasoline be injected exclusively and also at full load during the compression phase of the engine (12) by a multi-hole fuel injection device (22).

### STATE OF THE ART

The present invention relates to a method for operating an internal combustion engine wherein gasoline is so injected directly into a combustion chamber at least from time to time and air is so supplied to the combustion chamber at least from time to time that the gasoline/air mixture in the combustion chamber of the engine is present stratified.

Such a method is characterized generally as a method for gasoline-direct injection. In this method, the gasoline is charged with a very high pressure in a fuel collection line referred to as a rail. High pressure injection valves are connected to the fuel collection line and these valves inject the gasoline directly into the combustion chamber. The gasoline is so injected into the combustion chamber that a rather rich air/gasoline mixture is present in the direct vicinity of the ignition device which mixture can be ignited. The air/gasoline mixture is very lean in the remainder of the combustion chamber. In the extreme case, also pure air can be present in specific regions of the combustion chamber. Preferably, such a stratification of the gasoline is present in the combustion chamber in the entire operating range or characteristic field range of the engine.

An internal combustion engine, which is operated in accordance with the method mentioned initially herein, consumes relatively little gasoline and has a favorable emission performance. Nonetheless, the desire is present to still further reduce the fuel consumption of the engine which is operated in accordance with the known method. Such an internal combustion engine is known, for example, from DE 196 02 065 A1. Here, the fuel is introduced into the combustion chamber of the engine during the compression stroke by means of a main injection and an ignition injection. In this way, a stratification of the fuel arises in the combustion chamber. The stratified operation is provided in this engine up to a maximum of 80% of full load.

Present day internal combustion engines having gasoline-direct injection operate with a geometric compression ratio of approximately 12. A favorable fuel consumption is, however, achieved for a geometric compression ratio of approximately 13 to 16 (the geometric compression ratio is understood to be the sum of stroke volume and compression volume divided by the compression volume). Similar to a higher geometric compression ratio for which a higher compression pressure is present in the upper ignition dead point position of the piston, the effective pressure ratio (pressure ahead of charging/pressure after charging) can be increased for internal combustion engines having mechanical charging or having exhaust-gas turbocharging or having another charging systems (for example, pressure wave charging).

Such a high compression ratio is, up to now, not possible because, especially at full load operation, this can lead to uncontrolled precombustions of the gasoline disposed in the combustion chamber for a higher geometric and effective compression ratio. In the above, full load operation is at a high engine load for which fuel is injected usually during the intake stroke. The precombustions are caused by intensely heated components and regions in the combustion chamber. A further problem with respect to the service life of the engine is caused by a greatly increased tendency for knocking. The engine can be damaged by such knocking. For this reason, the compression ratio is so fixed in accordance with present day state of the art that the engine can be reliably operated at full load operation thereof without the danger of knocking and without uncontrolled combustions. This compression ratio lies below the compression ratio optimal for the consumption.

Furthermore, and above all for engines having precompression (that is, such engines which, for example, have a turbocharger), the mixture composition is at least from time to time enriched in full-load operation above the stoichiometric mixture composition (lambda=1) up to lambda values of 0.7. This enrichment is above all for thermal reasons. Such a mixture enrichment in the full load range of the engine, however, causes a serious disadvantage.

In the catalytic converter, only nitrogen oxide can be reduced to nitrogen and carbon dioxide with the aid of carbon monoxide because of the oxygen deficiency in the exhaust gas. However, no oxidation of uncombusted hydrocarbons takes place. These hydrocarbons reach the ambient untreated. The purification of the exhaust gas in the catalytic converter is therefore not optimal. In order to also be able to oxidize uncombusted hydrocarbons, one needs an additional secondary air pump which pumps additional air into the exhaust-gas channel. Such a pump has, however, a high power requirement and is therefore to be avoided if at all possible.

To counter the above, the compression ratio in present day engines is reduced. At idle and in part-load operation, a higher compression ratio would be favorable.

From the above, the task of the present invention results to further improve a method of the kind mentioned initially herein so that the consumption of gasoline is still further reduced especially at idle and in part-load operation and, at the same time, the emission performance is favorably reduced also in the upper part-load and full-load ranges.

This task is solved with the known method in that the gasoline is injected by a multi-hole fuel injection device exclusively and also at full load during the compression phase of the engine.

### ADVANTAGES OF THE INVENTION

The injection of fuel into the combustion chamber of the internal combustion engine takes place exclusively (that is, in the total possible load range of the engine) during the compression phase. Because of this late injection, the engine is exceptionally insensitive with respect to uncontrolled combustions or an unwanted self-ignition (knocking). In the conventional method, the gasoline is injected in the upper part-load range during the induction stroke. In this manner, remote zones of the combustion chamber are also wetted with gasoline which form a knocking source during an overheated combustion.

In contrast, with the late injection according to the invention, the injected fuel quantity concentrates up to the controlled ignition in the combustion chamber center while, in the peripheral zones, virtually pure combustion air without fuel components is distributed. In this way, no knocking sources and no knocking can occur. Also, no uncontrolled precombustion can take place. Also for the presence of hot combustion regions, the combustion in the method of the invention is triggered by the ignition or the injection time point and not by a high “ignition source” as can happen for an injection during the intake stroke.

Special measures, for example, a retarded ignition angle, are not required in the method of the invention for avoiding knocking. Insofar, the method of the invention also affords the advantage that the full engine torque is available at each time point. Further, no enrichment is any longer required. In lieu thereof, an essentially stoichiometric mixture of air and gasoline is always present at full load in the combustion chamber. In this way, the full exhaust-gas purification capacity (NOx-reduction and HC-oxidation) is available in accordance with the principle of the three-way catalytic converter.

In total, and because of the method of the invention, the corresponding internal combustion engine can be designed for clearly higher compression ratios, that is, the engine can be designed for compression ratios optimal with respect to consumption which, above all, favor a low consumption part-load operation. This is especially important for engines having a larger piston displacement because these engines, in general, are operated primarily in the part-load range. Furthermore, the possible use of equipment with which the compression ratio can be varied during operation of the engine is unnecessary. In this way, costs are saved.

Here, it is noted that internal combustion engines having gasoline-direct injection in accordance with the present day state of the art are operated in accordance with the wall-guided or air-guided method or a combination of both. In contrast to the spray-guided combustion method, which forms the basis of the invention, in both of the above combustion methods, injection takes place in full-load operation already during the induction stroke. Only in the spray-guided combustion method which is realized with the use of a multi-hole valve in accordance with the invention, an injection during the compression stroke is possible also at full load. Here, the injection can take place directly shortly before the ignition time point or simultaneously with the ignition time point, that is, the end of the injection can be later than the ignition time point.

In the spray-guided method according to the invention, the stratification of the gasoline in the combustion chamber takes place via the injection valve itself. In this method, an injector of an injection valve assumes the fuel distribution in the combustion chamber. The stratification is therefore independent of the flow of the inducted fresh air into the combustion chamber whereby a stratification is reliably possible with a mixture, which is locally enriched close to the ignition device, and a mixture, which is leaned in the remaining combustion chamber, at full load likewise as at idle. Full load can also be present at low rpms when the accelerator pedal is fully depressed and the engine receives the maximum air quantity and the fuel quantity (lambda=1) which is stoichio-metrically adapted to this air quantity.

Advantageous embodiments of the invention are presented in the dependent claims.

At first, an improvement is presented wherein injection of the gasoline takes place spatially close to an ignition device. In this way, it is ensured that under all operating conditions (especially also at full load and at a short time span between injection and ignition) an ignitable air/fuel mixture reaches up to the ignition device and can be ignited thereby.

With the method of the invention, it is possible that no throttling takes place during idle of the engine. Such a throttling is necessary in idle in conventional methods in order to avoid that the ignitable region of the air/fuel mixture is blown away from the ignition device because of an unthrottled intense air flow and therefore, at the ignition time point, no ignitable mixture is present any longer in the region of the ignition device.

Due to the fact that, in the invention, the gasoline is injected during the compression phase of the engine (that is, at a significantly shorter time interval to the ignition time point than in the state of the art), this danger of the ignitable air/fuel mixture being blown away from the injection-ignition device is no longer present. In this way, at low operating load and especially at idle, no throttling of the air flow is required any more so that even under these operating conditions, the engine can be operated without the throttle losses associated therewith.

Preferably, the geometric compression ratio of the engine lies in the range of 12 to 16. With such a compression ratio, a considerable reduction of the gasoline consumption is already present. Furthermore, compression ratios in this region are technically realizable without a problem.

The method of the invention is then especially suitable when the inducted air is precompressed. This is so because the operation of the engine at full load is not critical for precompressed induction air.

Furthermore, it is suggested that the ignition of the mixture take place via the ignition device after or just during the injection of the gasoline into the combustion chamber, preferably after a rotation of the crankshaft from the injection time point of approximately 0 to 30°. In this case, the injected gasoline still has sufficient time to propagate in the required manner (that is, to stratify); on the other hand, the time span between the injection and the ignition is also so short that the danger of “blowing away” of the fuel cloud from the ignition device is not given (that is, a reliable ignition takes place). The ignition can, however, also take place simultaneously with or during the injection. Injection and ignition take place, in total, at the combustion-optimal time point.

It is, however, also possible that the ignition of the mixture takes place by means of a glow device. In this case, there is therefore no separation between injection and ignition. Instead, the combustion operation is initiated by the start of the injection. The flame core formation also takes place at a point similar as in a spark ignition at an electrode, namely, in the hot surroundings of the glow device because the glow device itself may not be directly injected upon. The glow device includes preferably a glow pin. The advantage of such a glow device lies in its low price.

The glow device can be operated at significantly lower power at higher rpm or engine load than at low rpm and load. This is associated with the fact that, at higher load of the engine, less electrical energy must be supplied to maintain the glow device in a glowing state during the combustion.

The present invention relates also to a computer program which is suitable for carrying out the above method when it is executed on a computer. The computer program is especially preferred when it is stored on a memory, especially on a flash memory.

Finally, the invention relates also to an internal combustion engine having an injection device and an air supply device. The injection device injects gasoline directly into a combustion chamber at least from time to time and the air supply device so supplies air to the combustion chamber at least from time to time that the air/gasoline mixture in the combustion chamber is present stratified. In order to reduce the consumption of the engine, it is suggested that the gasoline be injected exclusively and also at full load during the compression phase of the engine by a multi-hole fuel injection device so that the stratification of the gasoline in the combustion chamber takes place via the fuel injection device. In this way, a higher compression ratio can be realized.

### DRAWING

In the following, an embodiment of the invention will be explained in detail with reference to the accompanying drawing. The drawing shows:

FIG. 1 is a block circuit diagram of an internal combustion engine having spray-guided injection;

FIG. 2 is a section through a region of the internal combustion engine of FIG. 1;

FIG. 3 is a bar graph wherein various operating parameters of the engine of FIG. 1 are placed opposite operating parameters of a conventional internal combustion engine;

FIGS. 4a to 4d show four bar graphs wherein operating parameters of the internal combustion engine of FIG. 1 are shown opposite operating parameters of a conventional internal combustion engine;

FIG. 5 is a diagram wherein fuel times and injection times are plotted against the crankshaft angle at low rpms; and, FIG. 6 is a diagram corresponding to FIG. 5 for higher rpms.

### DESCRIPTION OF THE EMBODIMENTS

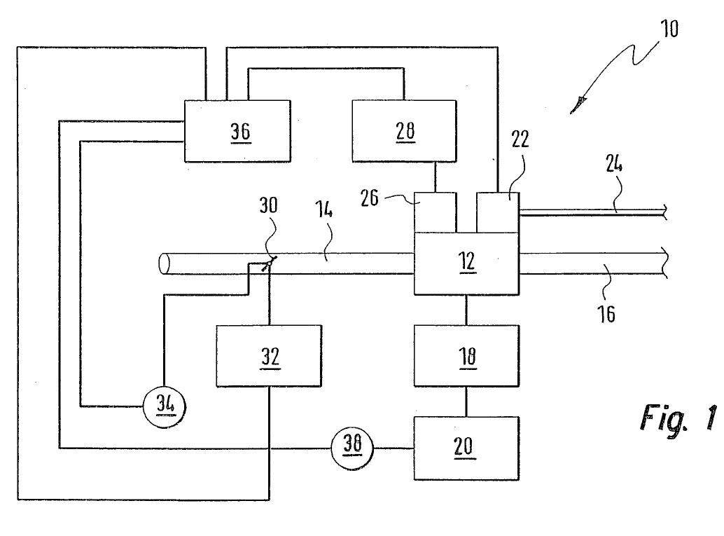

In FIG. 1, an internal combustion engine is identified by reference numeral 10. The engine includes a combustion chamber 12 to which air is supplied via an intake manifold 14. The exhaust gases are directed away from the combustion chamber 12 via an exhaust-gas pipe 16.

The combustion chamber 12 is delimited downwardly by a piston 18 which operates on a crankshaft 20. Gasoline is injected into the combustion chamber 12 via a high pressure injection valve 22 which is connected to a gasoline collection line 24. The gasoline collection line 24 is also known as a rail. The air/gasoline mixture disposed in the combustion chamber 12 is ignited by a spark plug 26 which is supplied by an ignition device 28.

A throttle flap 30 is present in the intake manifold 14 which is moved by an actuating motor 32. The angular position of the throttle flap 30 is detected by a position transducer 34 which transmits corresponding signals to a control apparatus 36. The control apparatus likewise receives signals from an rpm transducer 38 which taps the rpm of the crankshaft 20. At its output end, the control apparatus 36 is connected, on the one hand, to the actuating motor 32 of the throttle flap 30 and, on the other hand, to the ignition device 28 and finally to the high pressure injection valve 22.

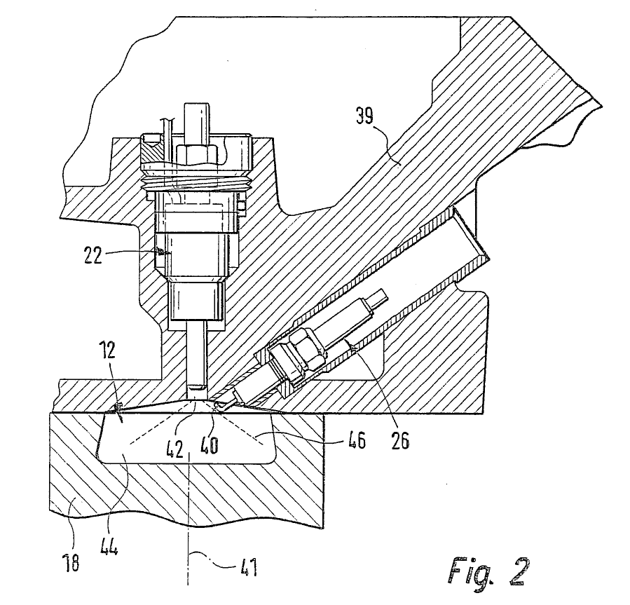

As shown in FIG. 2, the high pressure injection valve 22 is mounted in a cylinder head 39 essentially parallel to the piston longitudinal axis 41. The spark plug 26 is seated inclined from the side in the cylinder head 39 and, in such a manner, that its electrodes 40 are located in the direct vicinity and below an outlet 42 of the high pressure injection valve 22. A combustion chamber trough 44 is formed in the limiting wall of the piston 18 facing toward the high pressure injection valve 22 and the spark plug 26.

The internal combustion engine 10 is operated as follows:

During an induction phase in which the piston 18 moves away from the high pressure valve 22 and from the spark plug 26, air flows through the intake manifold 14 and an inlet valve (not shown) into the combustion chamber 12 formed between the piston 18 and the cylinder head 39. The actuating motor 32 is so controlled by the control apparatus 36 that the throttle flap 30 is aligned essentially parallel to the longitudinal length of the intake manifold 14. The exact position of the throttle flap 30 is transmitted to the control apparatus 36 via the position transducer 34. Position transducer 34, control apparatus 36 and actuating motor 32 form a closed control loop. There are no throttle losses because the throttle flap 30 is completely open during the induction phase. This, in turn, leads to the situation that the combustion chamber 12 can fill optimally with air.

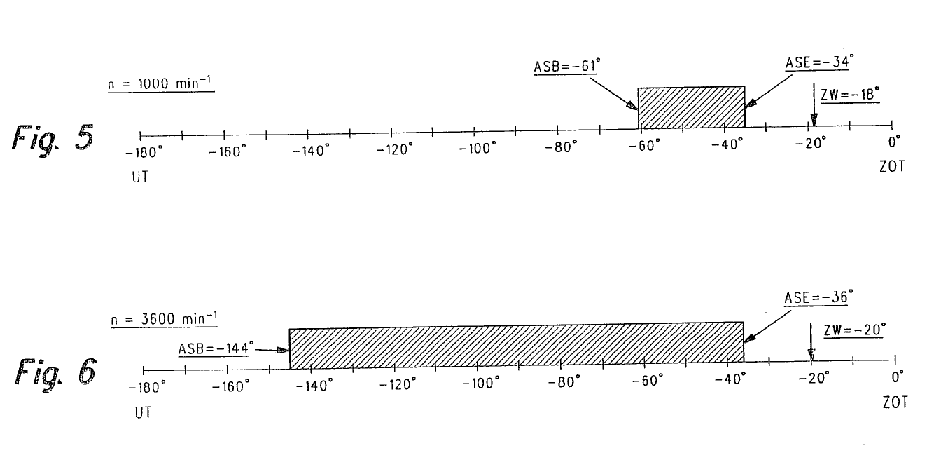

When the piston 18 has reached bottom dead center, the inlet valve is closed and the compression phase of the engine 10 begins. This is also shown in FIGS. 5 and 6. In FIGS. 5 and 6, embodiments are shown which define a certain optimum; the shown time relationships can shift for different pressures of the fuel in the gasoline collection line and/or injection valves configured differently (for example, different injection hole distribution).

If the engine 10 runs at a low rpm, this is transmitted to the control apparatus 36 by the rpm transducer 38. In this case, a compression of the air enclosed in the combustion chamber 12 first takes place exclusively during the compression phase. As shown in FIG. 5, the control apparatus 36 controls the high pressure injection valve 22 at an angle of the crankshaft 20 of approximately −61° ahead of top dead center such that the injection valve opens. At an angle of the crankshaft 20 of −34° TDC, the high pressure injection valve 22 is again closed by the control apparatus 36. At low rpm, only a relatively short injection pulse therefore takes place corresponding to the low power request.

As shown in FIG. 2, the gasoline is so injected by the high pressure injection valve 22 into the combustion chamber 12 that it is present stratified therein. This means that, especially at the center of the combustion chamber 12, that is, also in the region of the electrodes 40 of the spark plug 26 and within the combustion chamber trough, an overrich mixture exists with a local lambda value <1; whereas, in the peripheral zones of the combustion chamber 12, virtually pure air without gasoline components is distributed. The gasoline cloud, which is present in the combustion chamber 12 shortly after the injection by the high pressure injection valve 22, is indicated in FIG. 2 by a broken line and is identified by reference numeral 46. Even though there exists an overrich mixture having a local lambda value <1 in the combustion chamber center and a lean mixture with a lambda value >1 in the peripheral regions, the mixture overall in the combustion chamber 12 is stoichiometric with a lambda value of 1 which is computed or measured in the exhaust-gas flow of the exhaust-gas pipe 16.

At an angle of the crankshaft 20 of −18° TDC, the control apparatus 36 drives the ignition device 28 so that an ignition spark is generated at the electrodes 40 of the spark plug 26. Due to the presence of an overrich mixture in the region of the electrodes 40, this mixture can be reliably ignited and can be caused to flame. The time span is relatively short between the closing of the injection valve 22 and the generation of the ignition spark at the spark plug 26. For this reason, the time span is, however, sufficient in order to prepare the mixture in the required manner and to stratify the same.

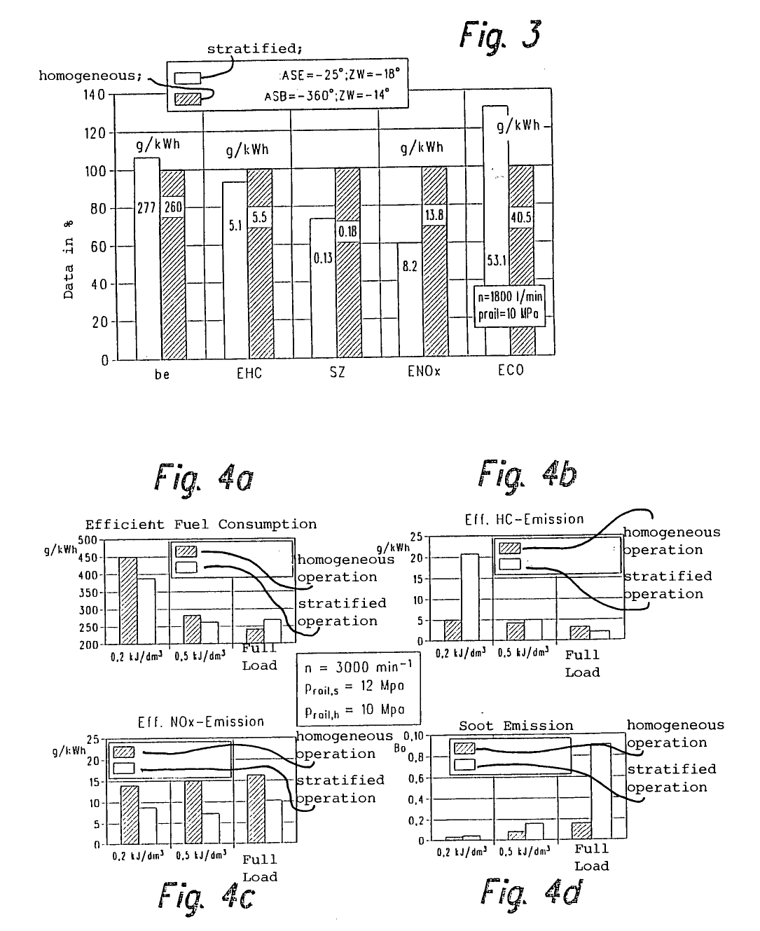

In total, the time is, however, so short that the zones of the combustion chamber 12, which are remote from the outlet 42 of the high pressure injection valve 22, are not wetted with gasoline so that in no phase of the operation of the engine 10 can there be an uncontrolled precombustion and also no knocking. In total, the mixture in the combustion chamber 12 is stoichiometric. For this reason, all possibilities of exhaust-gas purification via a three-way catalytic converter (not shown) are available. As shown in FIGS. 3 and 4, the internal combustion engine 10 therefore is characterized during operation by low exhaust-gas emissions and a favorable consumption of gasoline.

At higher rpm (see FIG. 6), the high pressure injection valve in the present embodiment is so driven by the control apparatus 36 that the injection start, which is referred to the angle position of the crankshaft 20, lies earlier than for lower rpm (see FIG. 5), here, at an angle of the crankshaft of −144° TDC. The injection is ended at an angle of the crankshaft 20 of −36° TDC and the ignition takes place at an angle of the crankshaft 20 of −20° TDC. The absolute time between the end of the injection and the ignition at higher rpm is relatively short. For this reason, an increase of the gasoline consumption results in this operating region of approximately 5% compared to an injection of the fuel during the intake phase (FIG. 4a). This increase in consumption occurs, however, only in the region of full load and can be compensated by a higher compression ratio and corresponding consumption-optimal ignition angles. As shown in FIG. 4d, a higher soot emission is present at full load which, however, still lies under 1. However, lower soot values are also still obtained with a fine tuning and a higher pressures of the fuel collecting line 24.

Even though it is not shown in the present embodiment, the internal combustion engine 10 is especially suited for use with a turbocharger which precompresses the air supplied to the combustion chamber 12. Since, as explained above, because of the spray-guided injection, an ignitable mixture is present in the combustion chamber center only shortly before the ignition, there is no danger of knocking and no danger of uncontrolled glow ignitions even for precompressed intake air.

In lieu of a spark plug 26, a glow device can also be used. Such a device known from diesel engines is relatively cost effective and does not require a complex ignition system. In this case, the combustion operation no longer takes place via an ignition of a spark but rather, the combustion operation is initiated by the start of the gasoline injection. The formation of a flame core, however, likewise takes place locally, namely, in the region, for example, of a glow pin of the glow device, that is, similar as in spark ignition at the electrodes 40 of the spark plug 26 in the present embodiment. At high rpm and/or especially at high load, the glow device can be operated at lower power.

1. Method of operating an internal combustion engine (10) wherein gasoline is injected at least from time to time directly into a combustion chamber (12) and air is so supplied to the combustion chamber (12) at least from time to time that the air/gasoline mixture in the combustion chamber (12) is present stratified, characterized in that the gasoline is injected exclusively and, also at full load during the compression phase of the engine (12) by a multi-hole fuel injection device (22) so that the stratification of the gasoline takes place in the combustion chamber (12) via the fuel injection device (22).

2. Method of claim 1, characterized in that the injection of the gasoline into the combustion chamber (12) takes place spatially close to an ignition device (40).

3. Method of the claims 2 and 3, characterized in that no throttling of the intake air takes place for low operating load, especially, at idle of the engine (12).

4. Method of one of the above claims, characterized in that the geometric compression ratio of the engine (10) lies in the range of 12 to 16.

5. Method of one of the above claims, characterized in that the intake air is precompressed.

6. Method of one of the above claims, characterized in that the ignition of the mixture takes place via an ignition device 40 after the injection of the gasoline into the combustion chamber (12), preferably after a rotation of the crankshaft (20) by approximately 0 to 30° and/or during the injection.

7. Method of one of the claims 1 to 5, characterized in that the ignition of the mixture takes place by means of a glow device.

8. Method of claim 7, characterized in that the glow device is operated at lower power at higher rpm and/or load than at lower rpm and/or load.

9. Computer program, characterized in that it is suitable for carrying out the method of one of the claims 1 to 8 when run on a computer.

10. Computer program of claim 9, characterized in that it is stored on a memory, especially on a flash memory.

11. Internal combustion engine having an injection device (22), which so injects gasoline directly into a combustion chamber (12) at least from time to time and having an air supply device (14) which so conducts air into the combustion chamber (12) at least from time to time that the air/fuel mixture in the combustion chamber (12) is present stratified, characterized in that the gasoline is injected exclusively and also at full load during the compression phase of the engine (12) by a multi-hole fuel injection device (22) so that the stratification of the gasoline in the combustion chamber (12) takes place via the fuel injection device (22).
